(19) United States
(12) Patent Application Publication
(10) Pub. No.: US 2016/0347003 A1
(43) Pub. Date: Dec. 1, 2016

(54) AUTOMATED PATH COMPENSATION SYSTEM FOR THREE DIMENSIONAL PRINTING SYSTEM

(71) Applicant: Caterpillar Inc., Peoria, IL (US)

(72) Inventor: Richard G. Marsh, Edwards, IL (US)

(73) Assignee: Caterpillar Inc., Peoria, IL (US)

(21) Appl. No.: 14/726,939

(22) Filed: Jun. 1, 2015

(51) Int. Cl. B29C 67/00

(52) U.S. Cl. CPC B29C 67/0088; B29L 2031/772

(57) ABSTRACT

An automated path compensation system for a material dispensing unit is provided. The automated path compensation system includes a material dispensing tip. The automated path compensation system also includes a movement control module coupled to the material dispensing tip. The movement control module is configured to identify at least one of an external feature and an internal feature of an intended geometry of an object. The movement control module is also configured to determine a path compensation for the material dispensing tip based on the identification and one or more parameters associated with the material dispensing tip. The movement control module is further configured to control a movement of the material dispensing tip based on the determination.

### TECHNICAL FIELD

The present disclosure relates to an automated path compensation system, and more particularly to the automated path compensation system for a three dimensional printing system.

### BACKGROUND

Manufacturing processes such as additive manufacturing or three dimensional (3D) printing techniques may be used for developing 3D objects. These 3D printing techniques include providing multiple layers of material on a work surface in a successive manner to form the 3D object. Generally, a digital model of the 3D object may be processed by computer control systems to slice the digital model into multiple layers. The output of the computer control system may be further communicated to a 3D printing tool to deposit material corresponding to each of the layers of the digital model.

A tool path is generally followed by the 3D printing tool for depositing the material. However, in some situations during the printing, some quantity may spill over beyond an intended geometry of the 3D object. The spill over may generally take place near boundaries of the 3D object, causing internal features of the 3D objects to be smaller than intended and/or external features to be larger than intended. In such cases, post production processes may have to be carried out on the 3D object to allow an actual geometry of the 3D object to match with the intended geometry. This may lead to increase in costs associated with the manufacturing of the 3D object.

U.S. Published Application Number 2011/0178621 describes a method for generating data for a support structure to be built with a deposition-based digital manufacturing system, the method comprising generating a convex hull polygon based on a boundary polygon of a layer of the support structure, offsetting the convex hull polygon inward, offsetting the boundary polygon outward, and generating an intersection boundary polygon based at least in part on the offset boundary polygon and the offset convex hull polygon.

### SUMMARY OF THE DISCLOSURE

In one aspect of the present disclosure, an automated path compensation system for a material dispensing unit is provided. The automated path compensation system includes a material dispensing tip. The automated path compensation system also includes a movement control module coupled to the material dispensing tip. The movement control module is configured to identify at least one of an external feature and an internal feature of an intended geometry of an object. The movement control module is also configured to determine a path compensation for the material dispensing tip based on the identification and one or more parameters associated with the material dispensing tip. The movement control module is further configured to control a movement of the material dispensing tip based on the determination.

In another aspect of the present disclosure, a method for automated path compensation associated with three dimensional printing is provided. The method includes identifying at least one of an external feature and an internal feature of an intended geometry of an object. The method also includes determining a path compensation for the material dispensing tip based on the identification and one or more parameters associated with the material dispensing tip. The method further includes controlling a movement of the material dispensing tip based on the determination.

In another aspect of the present disclosure, a three dimensional printing system is provided. The three dimensional printing system includes a power source and a melting unit. The three dimensional printing system also includes a material dispensing unit having a material dispensing tip. The three dimensional printing system further includes a movement control module coupled to the material dispensing tip. The movement control module is configured to identify at least one of an external feature and an internal feature of an intended geometry of an object. The movement control module is also configured to determine a path compensation for the material dispensing tip based on the identification and one or more parameters associated with the material dispensing tip. The movement control module is further configured to control a movement of the material dispensing tip based on the determination.

Other features and aspects of this disclosure will be apparent from the following description and the accompanying drawings.

### BRIEF DESCRIPTION OF THE DRAWINGS

FIG. 1 is a schematic view of an exemplary three dimensional (3D) printing system, according to one embodiment of the present disclosure;

FIG. 2 is a schematic view of an exemplary intended geometry of a 3D object to be manufactured using the 3D printing system of FIG. 1; and

FIG. 3 is a flowchart for a method of automated path compensation associated with 3D printing.

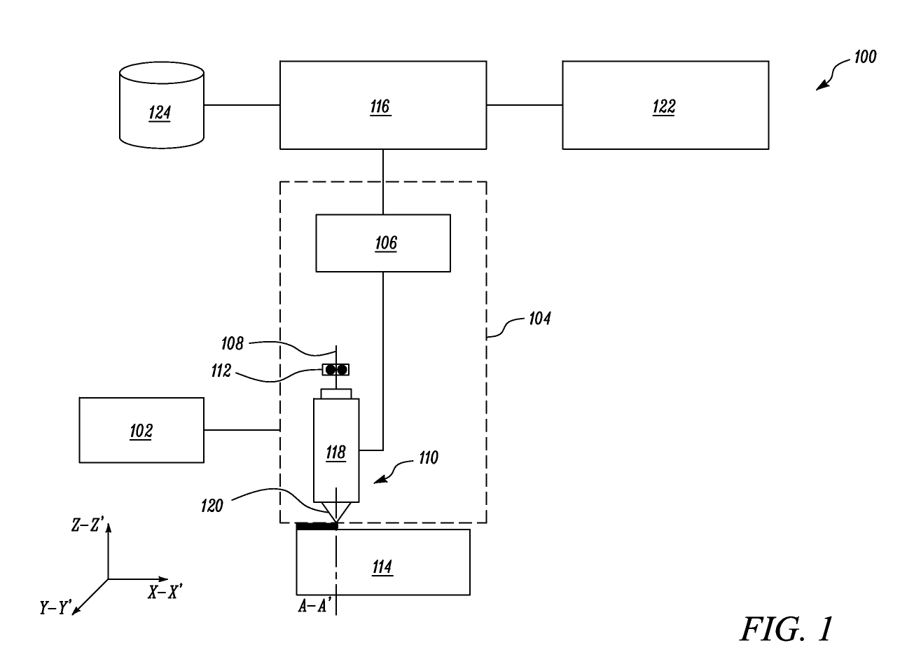

### DETAILED DESCRIPTION

Wherever possible, the same reference numbers will be used throughout the drawings to refer to the same or the like parts. FIG. 1 illustrates an exemplary three dimensional (3D) printing system 100, according to one embodiment of the present disclosure. The 3D printing system 100 of the present disclosure may be used to build 3D objects. The 3D printing system 100 disclosed herein may embody any known deposition-based digital manufacturing system including, but not limited to, extrusion-based systems, such as fused deposition modeling systems, fused filament fabrication systems, robocasting, a cold extrusion system, and/or jetting-based systems. Alternatively, the 3D printing system 100 may be associated with any other additive manufacturing process known in the art. The 3D printing system 100 may be used to manufacture 3D objects made of metallic and/or non-metallic materials, without limiting the scope of the present disclosure.

The 3D printing system 100 includes a power source 102. The power source 102 is configured to provide operating power to components of the 3D printing system 100, such as a material dispensing unit 104. The power source 102 may be communicably coupled to the material dispensing unit 104. In one example, the power source 102 may include a DC power supply. Alternatively, the power source 102 may embody batteries or cells, based on the type and size of application.

As shown in the accompanying figures, the 3D printing system 100 includes the material dispensing unit 104. The 3D printing system 100 of the present disclosure includes a single material dispensing unit 104. However, more than one material dispensing unit may be associated with the 3D printing system 100, based on system requirements. A filament 108 is wound on a coil and is unreeled to supply building material to a material dispensing head 110 associated with the material dispensing unit 104. The filament 108 may be stored in, and received from a supply source (not shown). An extruder drive 112 may be associated with the material dispensing unit 104. In one example, the extruder drive 112 may embody a worm-drive system that is configured to push the filament 108 into the material dispensing head 110 at a controlled rate. The extruder drive 112 may be operated by a motor, such as a stepper motor or a servo motor. The 3D printing system 100 may also include additional drive mechanisms (not shown) configured to assist in feeding the filament 108 to the material dispensing head 110.

Further, the material dispensing head 110 of the material dispensing unit 104 is movable with respect to an axis X-X′, an axis Y-Y′, and an axis Z-Z′. The axes X-X′, Y-Y′, Z-Z′ are defined with respect to a work surface 114. The material dispensing unit 104 may be movable with respect to the work surface 114. An actuation unit 106 may be associated with the material dispensing unit 104. The material dispensing unit 104 may include any actuating mechanism known in the art configured to move the material dispensing head 110. In one example, the 3D printing system 100 may be configured such that both of the material dispensing unit 104 and the work surface 114 are movable relative to each other.

The work surface 114 is a platform on which the 3D object is manufactured. In one example, the work surface 114 may be fixed. Alternatively, the work surface 114 may move along the axes X-X′, Y-Y′, or Z-Z′ based on signals provided from a control module, such as a movement control module 116, or any other controller associated with the 3D printing system 100.

The material dispensing head 110 includes a melting unit 118. The melting unit 118 is configured to heat the filament 108 received from the extruder drive 112 in order to melt the filament 108 so that the melted filament material can be extruded and deposited onto the work surface 114. It should be noted that the melting unit 118 may include any heating element known in the art capable of heating and melting the filament 108.

The material dispensing head 110 also includes a material dispensing tip 120. The material dispensing tip 120 may embody a nozzle. Dimension and design of the material dispensing tip 120 may vary as per operational requirements. In one example, the material dispensing tip 120 may include any one of a single tip or a dual tip nozzle, without limiting the scope of the present disclosure. In some examples, the material dispensing head 110 may include multiple dispensing tips 120 per material dispensing unit 110.

The material dispensing head 110 of the 3D printing system 100 is configured to move in any one of the axes X-X′, Y-Y′, and Z-Z′ in order to deposit extruded material on the work surface 114. The material dispensing head 110 may follow a tool path to deposit the extruded material and form the 3D object. Typically, the tool path of the material dispensing head 110 is determined by a computer (not shown). The computer may in turn be linked to the actuation unit 106. The computer may send control signals to the actuation unit 106. The actuation unit 106 is configured to move the material dispensing head 110 with respect to any one of the axes X-X′, Y-Y′, and Z-Z′.

The movement control module 116 is communicably coupled to the material dispensing unit 104. The material dispensing unit 104 is configured to receive control signals from the movement control module 116. Moreover, the movement control module 116 is communicably coupled to a computer 122. The movement control module 116 may receive a 3D digital model of the 3D object to be formed from the computer 122. Further, the movement control module 116 may cut the 3D digital model into multiple slices in various planes, preferably in a horizontal plane. In one example, the movement control module 116 may include slicing software, such as Simplify 3D, Cura, or Slic3r. The movement control module 116 is configured to receive command signals from the computer 122 indicative of the 3D digital model of the 3D object, and accordingly actuate the material dispensing head 110 via the actuation unit 106 to move in unison, or individually over the work surface 114 when forming the 3D object. Alternatively, the movement control module 116 may include pre-stored information related to the 3D digital model or other operations of the material dispensing unit 104. In such situation, the movement control module 116 may directly send control signals to the material dispensing unit 104.

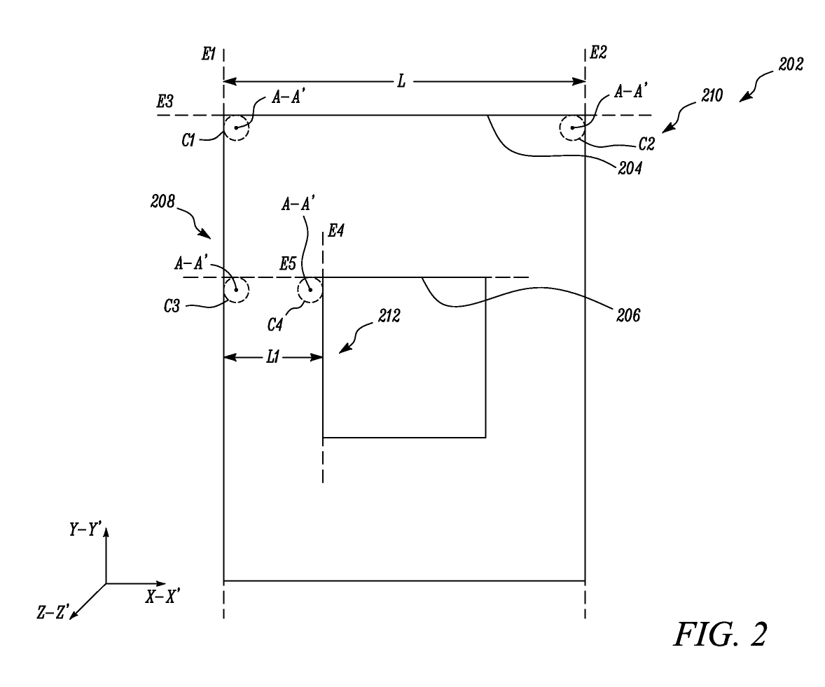

FIG. 2 is a schematic of an exemplary intended geometry 202 of the 3D object to be formed. Referring to FIGS. 1 and 2, the movement control module 116 is configured to determine and analyze the intended geometry 202 of at least one slice of the multiple slices of the 3D object. In one embodiment, the computer 122 may provide the intended geometry 202 to the movement control module 116. Alternatively, the intended geometry 202 may be stored in the movement control module 116. Further, based on the intended geometry 202 of the 3D object, the movement control module 116 determines an outer boundary or external feature 204. Additionally or optionally, the movement control module 116 determines an inner boundary or an internal feature 206 associated with the intended geometry 202. The features shown on the intended geometry 202 in FIG. 2 are exemplary in nature and do not limit the scope of the present disclosure.

The movement control module 116 is configured to determine a compensated tool path for the material dispensing head 110 to follow for depositing the extruded material based on the intended geometry 202 of the 3D object to be formed. The compensated tool path determined by the movement control module 116 is such that spillover material may be reduced or eliminated beyond or at the external feature 204 and the internal feature 206 of the 3D object.

Accordingly, the movement control module 116 is configured to determine a path compensation for the material dispensing tip 120 of the material dispensing head 110. The path compensation is determined based on the identification of the external feature 204, the internal feature 206, or both. The path compensation is also based on one or more parameters associated with the material dispensing tip 120. The parameters associated with the material dispensing tip 120 may include a radius of the material dispensing tip 120 and a thickness of the extruded material dispensed from the material dispensing tip 120. In one example, the path compensation is determined based on a correlation between the intended geometry 202 and the radius of the material dispensing tip 120. This correlation may be a mathematical relation between the intended geometry 202 of the 3D object and the radius of the material dispensing tip 120. The determination of the path compensation will be explained in detail later in this section. Data associated with radius of the material dispensing tip 120, and/or the width of the extruded material may be received from a database 124 (see FIG. 1).

The movement control module 116 is configured to control a movement of the material dispensing tip 120 based on the determination of the path compensation. For example, in case of the external feature 204 of the 3D object, the path compensation determined by the movement control module 116 is such that the movement control module 116 is configured to restrict a movement of a center line A-A′ of the material dispensing tip 120 beyond the external feature 204 of the intended geometry 202.

For the purpose of explanation, the path compensation will be described with reference to a portion of the external feature 204 shown in FIG. 2. In this case, the movement control module 116 is configured to restrict the movement of the material dispensing tip 120 along the axes X-X′ and Y-Y′ such that the material dispensing tip 120 does not move beyond lines “E1”, “E2”, and “E3”. The lines “E1”, “E2”, and “E3” are defined such that the lines “E1” and “E2” are parallel to each other. Further, the line “E3” is perpendicular to the lines “E1” and “E2”, in line with the external feature 204 of the intended 3D object design.

In this situation, an exemplary position of a circumference of the material dispensing tip 120 as located above the work surface 114 is denoted using circles “C1” and “C2”, in order to depict the respective initial and subsequent positions of the material dispensing tip 120 during the printing process. The path compensation is such that the material dispensing tip 120 is controlled from moving beyond the lines “E1” and “E3” for the circle “C1” and the lines “E2” and “E3” for the circle “C2” relative to the axes X-X′ and Y-Y′ so that the radius of the material dispensing tip 120 may be compensated for.

For example, the material dispensing tip 120 may be initially positioned at a location on the work surface 114 denoted by the circle “C1”. The movement control module 116 is configured to provide signals to the actuation unit 106 to move the material dispensing tip 120 in such a manner that the center line A-A′ of the material dispensing tip 120 does not go beyond the lines “E1” and “E3” at a first end 208. Further, the movement control module 116 is configured to provide control signals for moving the material dispensing tip 120 along the work surface 114 to deposit the extruded material such that on reaching a second end 210, the material dispensing tip 120 is prevented from extending beyond the line “E2” and the center line A-A′ remains within the line “E2” by a distance equivalent to that of the radius of the material dispensing tip 120.

For example, if the external feature 204 of the intended geometry 202 has a length “L” of 10 mm and the radius of the material dispensing tip 120 is 0.5 mm. The movement control module 116 may move the center line A-A′ of the material dispensing tip 120 by a distance of 0.5 mm along the axis X-X′ to be positioned at the location depicted by the circle “C1”. In such a situation, the path compensation may be such that the center line A-A′ of the material dispensing tip 120 moves a distance of 9 mm due to compensation based on the radius of the material dispensing tip 120. Accordingly, due to the path compensation determined by the movement control module 116, the center line A-A′ travel distance is lesser than that of the length “L” of the intended geometry 202. The movement control module 116 may reduce or eliminate any spilling of the extruded material beyond the external feature 204.

Further, for the internal feature 206, the path compensation is based on restricting the movement of the center line A-A′ of the material dispensing tip 120 beyond the internal feature 206 of the intended geometry 202. For a portion of the internal feature 206, the movement control module 116 is configured to restrict the movement of the material dispensing tip 120 along the axes X-X′ and Y-Y′ such that the material dispensing tip 120 does not move beyond lines “E1”, “E4” and “E5”. The lines “E1, “E4” and “E5” are provided such that the lines “E1” and “E4” are parallel. Further, the line “E5” is perpendicular to the lines “E1” and “E4” based on the exemplary intended geometry 202 of the 3D object.

More particularly, with respect to the internal feature 206, the movement control module 116 is configured to provide control signal to move the material dispensing tip 120 in such a manner relative to the axes X-X′ and Y-Y′, such that the position of the circumference of the material dispensing tip 120 at different instants of time during the printing process is denoted by circles “C3” and “C4”. As explained above with reference to the external feature 204, the movement control module 116 is configured to control the movement of the center line A-A′ of the material dispensing tip 120 with respect to the axes X-X′ and Y-Y′, such that the circle “C3” lies within the lines “E1” and “E5” and the circle “C4” lies within the lines “E4” and “E5” respectively.

Although explained with reference to one portion of the intended geometry 202, the movement control module 116 may appropriately control the movement of the material dispensing tip 120 relative to other external or internal features in a similar manner. The same path compensation may be followed by the movement control module 116 for the multiple slices to deposit the extruded material in order to form the 3D object.

The computer 122 may be embodied in the form of a general purpose computer having machine readable instructions for generating the 3D digital model of the 3D object to be formed and/or performing any other functions that are consistent with aspects of the present disclosure. Although the movement control module 116 disclosed herein is being coupled to the computer 122, it will be appreciated that in alternative embodiments, the movement control module 116 itself can be configured with machine readable instructions to generate the 3D digital model of the 3D object to be formed.

The movement control module 116 may embody a single microprocessor or multiple microprocessors that include components for individually controlling operations of the material dispensing unit 104 based on inputs from an operator and based on sensed or other known operational parameters. Numerous commercially available microprocessors can be configured to perform the functions of the movement control module 116. It should be appreciated that the movement control module 116 could readily be embodied in a general machine microprocessor capable of controlling numerous machine functions.

The movement control module 116 may include a memory, a secondary storage device, a processor, and any other components for running an application. Various routines, algorithms, and/or programs can be programmed within the movement control module 116 for execution thereof to generate the 3D digital model of the 3D object to be formed. Therefore, one of ordinary skill in the art will also appreciate that the movement control module 116 and the computer 122 could be integral to one another, or distinct from one another as shown in the illustrated embodiment of FIG. 1, without deviating from the spirit of the present disclosure.

### INDUSTRIAL APPLICABILITY

The 3D printing system 100 of the present disclosure includes the movement control module 116. The movement control module 116 determines the relative position of the internal and external features 204, 206 of the intended geometry 202. Further, the movement control module 116 determines the path compensation based on the identification of the internal and external features 204, 206, and the radius of the material dispensing tip 120 and/or the thickness of the extruded material. By compensating for the tool path based on the size of the material dispensing tip 120, the spillover material that is otherwise caused due to opening size of the material dispensing tip 120 may be reduced or avoided. The path compensation using the movement control module 116 allows higher accuracy 3D objects to be generated that do not require significant rework or redesign to compensate for the radius of the material dispensing tip 120. Also, the 3D objects manufactured using the 3D printing system 100 of the present disclosure may be easily assembled with another object.

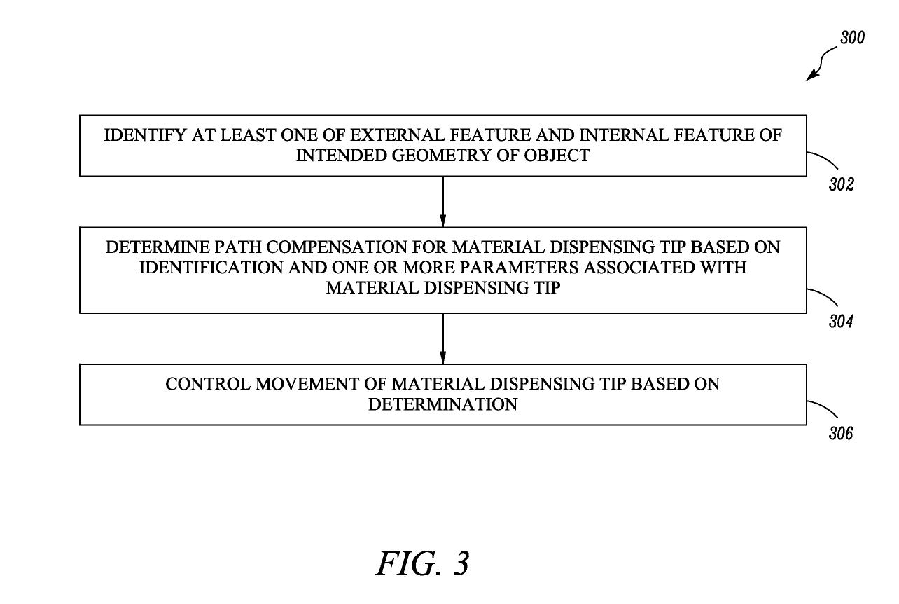

FIG. 3 is a flowchart for a method 300 of automated path compensation associated with the 3D printing system 100. At step 302, the movement control module 116 identifies at least one of the external feature 204 and the internal feature 206 of the intended geometry 202 of the 3D object. At step 304, the movement control module 116 determines the path compensation for the material dispensing tip 120 based on the identification of the external and internal feature 204, 206 and one or more parameters associated with the material dispensing tip 120.

At step 306, the movement control module 116 controls the movement of the material dispensing tip 120 based on the determination of the path compensation. The movement control module 116 restricts the movement of the center line A-A′ of the material dispensing tip 120 beyond the internal feature 206 of the intended geometry 202. Further, the movement control module 116 restricts the movement of the center line A-A′ of the material dispensing tip 120 beyond the external feature 204 of the intended geometry 202.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An automated path compensation system for a material dispensing unit, the automated path compensation system comprising:
a material dispensing tip; and
a movement control module coupled to the material dispensing tip, the movement control module configured to:
identify at least one of an external feature and an internal feature of an intended geometry of an object;
determine a path compensation for the material dispensing tip based on the identification and one or more parameters associated with the material dispensing tip; and
control a movement of the material dispensing tip based on the determination.

2. The automated path compensation system of claim 1, wherein the one or more parameters includes a radius of the material dispensing tip and a thickness of material extruded from the material dispensing tip.

3. The automated path compensation system of claim 1, wherein the movement control module is configured to reduce spillover material at the at least one of the external feature and the internal feature of the object.

4. The automated path compensation system of claim 1, wherein the path compensation is based on restricting a movement of a center line of the material dispensing tip beyond the internal feature of the intended geometry.

5. The automated path compensation system of claim 1, wherein the path compensation is based on restricting a movement of a center line of the material dispensing tip beyond the external feature of the intended geometry.

6. The automated path compensation system of claim 1, wherein the path compensation is determined based on a correlation between the intended geometry and a radius of the material dispensing tip.

7. A method for automated path compensation associated with three dimensional printing, the method comprising:
identifying at least one of an external feature and an internal feature of an intended geometry of an object;
determining a path compensation for the material dispensing tip based on the identification and one or more parameters associated with the material dispensing tip; and
controlling a movement of the material dispensing tip based on the determination.

8. The method of claim 7, wherein the one or more parameters include a radius of the material dispensing tip and a thickness of material extruded from the material dispensing tip.

9. The method of claim 7 further comprising:
reducing spillover material at the at least one of the external feature and the internal feature of the object.

10. The method of claim 7, wherein the path compensation is determined based on a correlation between the intended geometry and a radius of the material dispensing tip.

11. The method of claim 7 further comprising:
restricting a movement of a center line of the material dispensing tip beyond the internal feature of the intended geometry.

12. The method of claim 7 further comprising:
restricting a movement of a center line of the material dispensing tip beyond the external feature of the intended geometry.

13. A three dimensional printing system comprising:
a power source;
a melting unit;
a material dispensing unit having a material dispensing tip; and
a movement control module coupled to the material dispensing tip, the movement control module configured to:
identify at least one of an external feature and an internal feature of an intended geometry of an object;
determine a path compensation for the material dispensing tip based on the identification and one or more parameters associated with the material dispensing tip; and
control a movement of the material dispensing tip based on the determination.

14. The three dimensional printing system of claim 13 wherein the one or more parameters include a radius of the material dispensing tip and a thickness of material extruded from the material dispensing tip.

15. The three dimensional printing system of claim 13, wherein the movement control module is configured to reduce spillover material at the at least one of the external feature and the internal feature of the object.

16. The three dimensional printing system of claim 13, wherein the path compensation is based on restricting a movement of a center line of the material dispensing tip beyond the internal feature of the intended geometry.

17. The three dimensional printing of claim 13, wherein the path compensation is based on restricting a movement of a center line of the material dispensing tip beyond the external feature of the intended geometry.

18. The three dimensional printing system of claim 13, wherein the path compensation is determined based on a correlation between the intended geometry and a radius of the material dispensing tip.
